(19) United States
(12) Patent Application Publication
(10) Pub. No.: US 2024/0086958 A1
(43) Pub. Date: Mar. 14, 2024

(54) ENHANCE SALES OPPORTUNITIES AT PHYSICAL COMMERCE CHANNELS

(71) Applicant: INTERNATIONAL BUSINESS MACHINES CORPORATION, ARMONK, NY (US)

(72) Inventors: Sidharth Ullal, Chennai (IN); Raghuveer Prasad Nagar, Kota (IN); Shresta Muniyappa, Kolar (IN); Neelesh Gupta, Bangalore (IN)

(21) Appl. No.: 17/931,984

(22) Filed: Sep. 14, 2022

(51) Int. Cl. G06Q 30/02

(52) U.S. Cl. CPC G06Q 30/0211; G06Q 30/0203; G06Q 30/0281

(57) ABSTRACT

A method, computer system, and a computer program product for enhancing a customer experience is provided. The present invention may include collecting data for a store visit. The present invention may include determining whether to offer the user one or more rewards based on the data collected. The present invention may include determining the one or more rewards to offer the user. The present invention may include presenting the one or more rewards to the user.

### BACKGROUND

The present invention relates generally to the field of computing, and more particularly to data driven physical commerce channels.

Many retailers and/or businesses may offer multi-channel services. Multi-channel services may include, but are not limited to including, a website, mobile application, physical store, call center, amongst others. E-commerce has been steadily increasing over time which may have an adverse impact on the physical channel services such as in-person stores. Physical commerce channels may be disadvantaged by a lack of data specific to consumers and/or their ability to provide incentives specific to those consumers.

Retailers and/or business may require personalized incentives to drives sales in physical commerce channels.

### SUMMARY

Embodiments of the present invention disclose a method, computer system, and a computer program product for enhancing a customer experience is provided. The present invention may include collecting data for a store visit. The present invention may include determining whether to offer the user one or more rewards based on the data collected. The present invention may include determining the one or more rewards to offer the user. The present invention may include presenting the one or more rewards to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of an exemplary computing environment according to at least one embodiment; and

FIG. 2 is an operational flowchart illustrating a process for enhancing customer experience according to at least one embodiment.

### DETAILED DESCRIPTION

The following described exemplary embodiments provide a system, method and program product for enhancing customer experience. As such, the present embodiment has the capacity to improve the technical field of data driven physical commerce channels by providing personalized rewards to a user prior to and/or during a store visit based on data received. More specifically, the present invention may include collecting data for a store visit. The present invention may include determining whether to offer the user one or more rewards based on the data collected. The present invention may include determining the one or more rewards to offer the user. The present invention may include presenting the one or more rewards to the user.

As described previously, Many retailers and/or businesses may offer multi-channel services. Multi-channel services may include, but are not limited to including, a website, mobile application, physical store, call center, amongst others. E-commerce has been steadily increasing over time which may have an adverse impact on the physical channel services such as in-person stores. Physical commerce channels may be disadvantaged by a lack of data specific to consumers and/or their ability to provide incentives specific to those consumers.

Retailers and/or business may require personalized incentives to drives sales in physical commerce channels.

Therefore, it may be advantageous to, among other things, collect data for a store visit, determine whether to offer the user one or more rewards based on the data collected, determine the one or more rewards to offer the user, and present the one or more rewards to the user.

According to at least one embodiment, the present invention may improve sales at physical commerce channels by utilizing user specific rewards to improve sales activity.

According to at least one embodiment, the present invention may improve the user experience with a physical store by offering one or more rewards based on data received prior to and/or during a store visit.

According to at least one embodiment, the present invention may improve the user experience by providing assistance to the user during a store visit, such as, but not limited to, a store layout, directions within the store to one or more specific items, recommended items, and/or enabling the user to request staff assistance within a user interface.

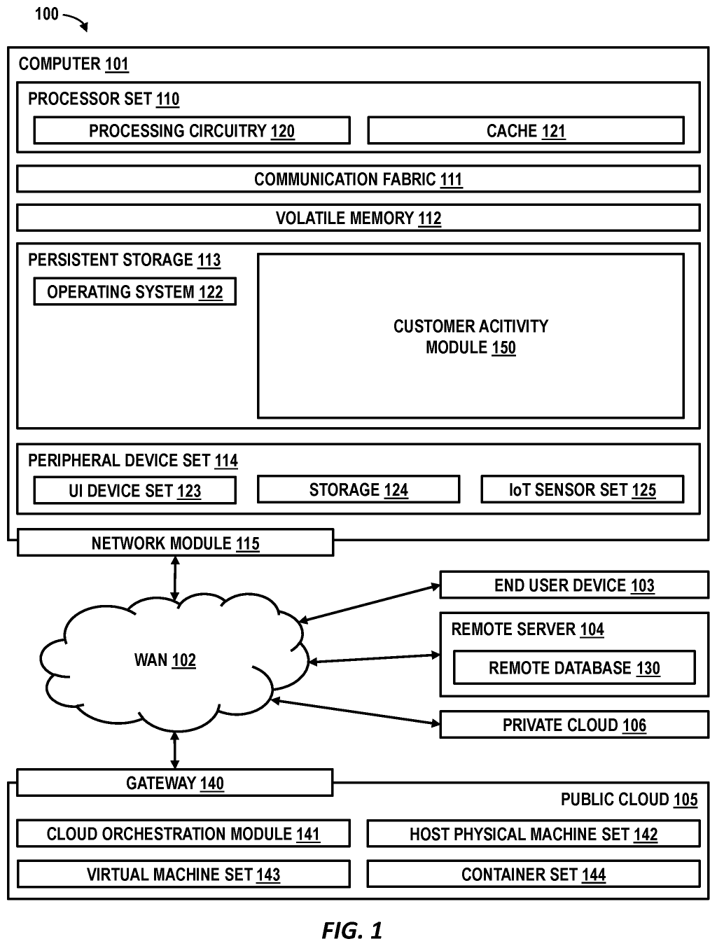

Referring to FIG. 1, Computing environment 100 contains an example of an environment for the execution of at least some of the computer code involved in performing the inventive methods, such as providing personalized rewards to a user prior to and/or during a store visit based on data received by the customer activity module 150. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

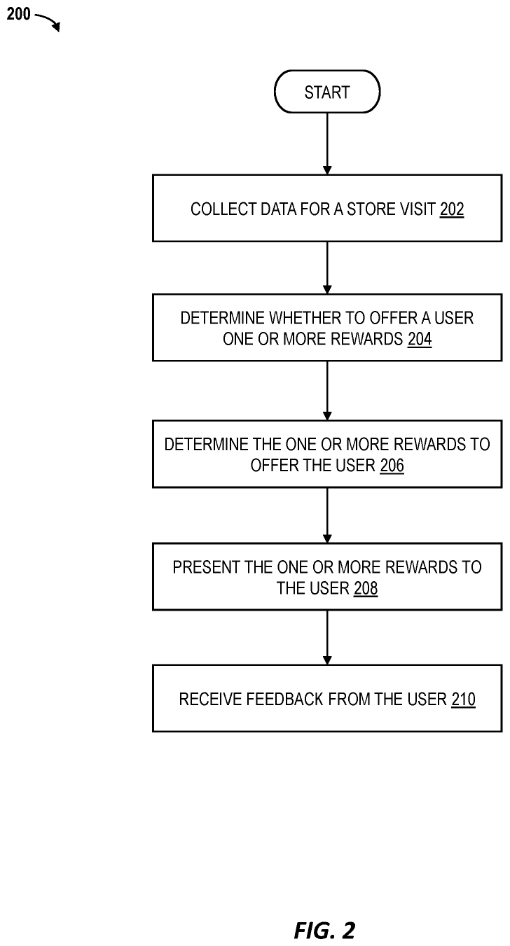

According to the present embodiment, the computer environment 100 may use the customer activity module 150 to providing personalized rewards to a user prior to and/or during a store visit. The enhanced customer experience method is explained in more detail below with respect to FIG. 2.

Referring now to FIG. 2, an operational flowchart illustrating the exemplary customer activity process 200 used by the customer activity module 150 according to at least one embodiment is depicted.

At 202, the customer activity module 150 collects data for a store visit. The customer activity module 150 may collect data for the store visit from the user directly, indirectly, and/or from one or more publicly available resources. The customer activity module 150 may collect data for the store visit directly through the EUD 103, data collected directly from the user may require manual entry by the user. The data collected indirectly from the user may be data gathered indirectly based on one or more connected devices amongst other data sources which may be gathered automatically.

The user may provide data directly through a user interface displayed by the customer activity module 150 on the EUD 103. The customer activity module 150 may display the user interface to the user on the EUD 103 in at least an internet browser, dedicated software application, and/or as an integration with a third party software application. The user may provide data prior to, during, and/or following the store visit. The customer activity module 150 may display one or more prompts to the user on the EUD 103. The one or more prompts may include data entry for, but is not limited to including data entry for, means of transportation, distance to be traveled, user feedback with respect to one or more offered rewards, ratings for the user experience, amongst other prompts which may be presented to the user prior to, during, and/or following the store visit. The user may also create a user profile within the user interface which may include information allowing the customer activity module 150 to offer personalized rewards to the user. All information included in the user profile and/or received by the user in the user interface shall not be construed as to violate or encourage the violation of any local, state, federal, or international law with respect to privacy protection. No information received and/or included in the user profile shall be stored by the customer activity module without expressed consent from the user. The user may add and/or delete information in the user interface at any time.

The user may also scan one or more products during the store visit using the EUD 103 and/or other devices such as, but not limited to, a smartphone, smart glasses, bar code scanner, RFID (Radio Frequency Identification) scanner, QR code scanner, amongst other devices the user may associate with their user profile. The customer activity module 150 may retrieve information about each of the one or more products scanned by the user during the store visit from a catalog of products stored in a database 130 (e.g., knowledge corpus) maintained by the customer activity module 150. The catalog of products may include, but is not limited to including, product type, product properties, amongst other data. The product properties may include information such as, product weight, recommended storage details, amongst other information.

The customer activity module 150 may also gather information with respect to the one or more products using images and/or video feed. The images and/or video feed may be received directly from the EUD 103 and/or one or more IoT devices within the store. The customer activity module 150 may analyze the images and/or video received utilizing one or more image analysis tools to identify the one or more products in the image and/or video. The one or more image analysis tools may include, but are not limited to including, object segmentation techniques, pre-trained classifiers, object-based image analysis, a Convolutional Neural Network (CNN), supervised/unsupervised image classification, amongst other image analysis and/or classification tools. The customer activity module 150 may leverage at least the one or more image analysis tools as well as the catalog of products stored in the database 130 (e.g., knowledge corpus) in identifying the one or more products.

The customer activity module 150 may collect data indirectly from the user based on at least one or more connected devices and/or other permissions given by the user through the user interface, amongst other means of collecting data automatically. The user may permit the customer activity module 150 to collect data from one or more smart wearable devices, IoT (Internet of Things) devices, calendar data, Global Positioning Systems (GPS) of the one or more smart wearable devices, IoT devices associated with a user's vehicle or means of transportation, one or more linked social media profiles, location data, cameras, infrared sensors, pressure sensors, amongst other data sources which may be monitored in real time and/or collected automatically by the customer activity module 150. The customer activity module 150 may also receive and/or access data from additional sources such as, a user's shopping cart, automated garbage disposal systems, IoT refrigerator (e.g., smart refrigerator), IoT microwave (e.g., smart microwave), IoT oven (e.g., smart oven) contained equipped with smart shelves (e.g., smart shelves), IoT enabled appliances, amongst other IoT enabled/smart appliances which may enable the customer activity module 150 to monitor consumption patterns and/or preferences of the user. As will be explained in more detail below, the above data may be utilized by the customer activity module 150 in determining one or more rewards to offer the user. All data collected automatically by the customer activity module 150 shall not be construed as to violate or encourage the violation of any local, state, federal, or international law with respect to privacy protection. The customer activity module 150 may require consent from the user for which the data may be received automatically. Additionally, the user may be able to monitor the data collected and/or the sources of the data collected in the user profile. The user may disconnect any of the sources of data at any time and the customer activity module 150 may remind the user periodically which sources the user may have previously permissioned.

All data received, accessed, and/or collected by the customer activity module 150 including data received from the EUD 103, smart wearable devices, and/or IoT devices shall not be construed as to violate or encourage the violation of any local, state, federal, or international law with respect to privacy protection. The customer activity module 150 may further require periodic consent with respect to any additional data collected. The customer activity module may only receive and/or store data relevant to the store visit.

At 204, the customer activity module 150 determines whether to offer the user one or more rewards based on the data collected. The customer activity module 150 may utilize at least the data collected at step 202 in determining whether to offer the user rewards based on the store visit. The customer activity module 150 may utilize one or more thresholds in determining whether to offer the user the rewards.

The one or more thresholds may include, but are not limited to including, statistical thresholds, thresholds set by the user, and/or thresholds recommended by a professional. The thresholds recommended by the professional may be set by the user themselves and/or by a medicine-as-a-service SaaS (software as a service) practice which may be integrated with the customer activity module. The one or more thresholds may be user specific and/or predetermined values based on certain data. For example, a user specific reward may be based on calendar data such as birthdays, anniversaries, and/or other events. Thresholds based on predetermined values may be for example discounts offered to user's based on their distance from the store location and/or exceeding a number of daily steps. The one or more smart wearable devices described at step 202, may send a notification to the customer activity module 150 that one or more thresholds and/or goals have been exceeded. In this example, a fitness tracker associated with the user may notify the customer activity module that a threshold or goal for 10,000 steps has been exceeded for a given time period.

At 206, the customer activity module 150 determines the one or more rewards to offer to the user. The customer activity module 150 may determine the one or more rewards to offer the user based on at least the one or more thresholds exceeded by the user and/or an analysis of the data provided by the user at step 202.

The customer activity module 150 may utilize one or more machine learning algorithms in determining the one or more rewards to offer the user. The reward generation may be a system in itself due to a multitude of factors which may require consideration, such as, but not limited to, allergies, store inventory, cost of reward, usability of the rewards, amongst other factors which may require the use of more than one machine learning algorithm.

The customer activity module 150 may utilize data such as, but not limited to, calendar data, one or more linked social media profiles, and/or the user profile using one or more linguistic analysis techniques. The one or more linguistic analysis techniques may be utilized in determining an intent of the user's store visit such that the customer activity module 150 may provide one or more rewards which may be specific to the user. The one or more linguistic analysis techniques may include, but are not limited to including, a machine learning model with Natural Language Processing (NLP), Latent Dirichlet Allocation (LDA), speech-to-text, Hidden markov models (HMM), N-grams, Speaker Diarization (SD), Semantic Textual Similarity (STS), Keyword Extraction, amongst other analysis techniques, such as those implemented in IBM Watson® (IBM Watson and all Watson-based trademarks are trademarks or registered trademarks of International Business Machines Corporation in the United States, and/or other countries), IBM Watson® Speech to Text, IBM Watson® Tone Analyzer, IBM Watson® Natural Language Understanding, IBM Watson® Natural Language Classifier, amongst other implementations. The one or more linguistic analysis techniques may be utilized by the customer activity module in determining the one or more rewards to be presented to the user and rank the one or more rewards.

The one or more rewards may include, but are not limited to including, priority check-out, eatables on arrival, free home delivery, free drinks, discounts on one or more products, product recommendations, staff assistance, amongst other rewards which may be determined based on the data received and/or accessed by the customer activity module 150.

For example, prior to the store visit the customer activity module 150 may receive data such as a number of steps taken to arrive at the store from a smart wearable device associated with the user. During the store visit the customer activity module 150 may receive data based on the one or more products scanned by the user. Additionally, based on the user's integrated calendar data the customer activity module 150 may determine the user is in a hurry or is at the store with a specific purpose. As will be explained in more detail below, in these examples, the one or more rewards offered by the customer activity module may correspond to the data received prior to, during, and/or following the store visit. Such as, a free drink and/or home delivery based on the number of steps taken to arrive at the store, discounts corresponding to the one or more products scanned by the user, and/or express checkout based on the integrated calendar data.

At 208, the customer activity module 150 presents the one or more rewards to the user. The customer activity module 150 may present the one or more rewards to the user on the EUD 103 using the user interface.

The customer activity module 150 may present the one or more rewards to the user based on the ranking determined at step 206. The user may select at least one of the one or more rewards presented. The customer activity module 150 may present a ranking of one or more rewards to the user intermittently as a corresponding threshold is exceeded. For example, the user may exceed a threshold for physical activity prior to arriving at the store. The customer activity module 150 may present the user with the option to claim a reward of either a free water, sports drink, or healthy snack. When the user arrives at the store which may be determined based on location data described at step 202 the user may select one of the rewards prior to shopping. As the user is shopping and scanning items the customer activity module may determine that a threshold weight has been exceeded for the items to be purchased by the user. Accordingly, the customer activity module 150 may send an alert to the EUD 103 device of the user with another ranking of one or more rewards. These rewards may include a 5% discount and/or free home delivery.

The customer activity module 150 may also provide assistance to the user during the store visit, such as a store layout, directions within the store to one or more items, a personalized map that enables the user to travel directly from item to item on a shopping list, recommended items, and/or enable the user to request staff assistance within the user interface on the EUD 103.

At 210, the customer activity module 150 receives feedback from the user. The customer activity module may utilize feedback from the user in providing future rewards to the user. The customer activity module 150 may receive feedback from the user in the user interface presented to the user on the EUD 103. The customer activity module 150 may utilize one or more prompts in collecting feedback from the user. The one or more prompts may include, but are not limited to including, numerical values, sliding scales, and/or means of quantify a user experience.

The customer activity module 150 may store the one or more selected rewards by the user, the items purchased by the user, user feedback, amongst other data in the database 130 (e.g., knowledge corpus). The customer activity module 150 may utilize the data stored in the database 130 (e.g., knowledge corpus) in providing future rewards to the user.

The customer activity module 150 may incentivize the user to provide feedback by adjusting the one or more thresholds for receiving the one or more rewards based on the quality and/or quantity of the received feedback. For example, the customer activity module may reduce the activity threshold from 2000 to 1500 steps based on the feedback received.

It may be appreciated that FIG. 2 provides only an illustration of one embodiment and do not imply any limitations with regard to how different embodiments may be implemented. Many modifications to the depicted embodiment(s) may be made based on design and implementation requirements.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The present disclosure shall not be construed as to violate or encourage the violation of any local, state, federal, or international law with respect to privacy protection.

1. A method for enhancing a customer experience, the method comprising:
collecting data for a store visit;
determining whether to offer a user one or more rewards based on the data collected and one or more thresholds corresponding to one or more user activities;
determining the one or more rewards to offer the user, wherein the one or more rewards are determined utilizing a machine learning model based on exceeding at least one of the one or more thresholds and an analysis of the data collected for the store visit;
presenting the one or more rewards to the user on an end user device, wherein the one or more rewards are ranked within a user interface based on an intent of the user's store visit, and wherein the user selects at least one of the one or more rewards in the user interface; and
receiving feedback from the user with respect to the one or more rewards, in response to one or more prompts displayed on the end user device, wherein the feedback is stored in a knowledge corpus and utilized in improving future reward offer determinations by the machine learning model.

2. The method of claim 1, further comprising:
adjusting the one or more thresholds corresponding to the one or more user activities based on a quality or quantity of the feedback received.

3. The method of claim 1, further comprising:
providing assistance to the user during the store visit, wherein the assistance includes a personalized map from item to item of a shopping list based upon a Global Positioning Systems (GPS) data received from a smart wearable device associated with the user.

4. The method of claim 1, wherein collecting data for the store visit further comprises:
utilizing at least data provided by the user prior to the store visit and during the store visit, wherein the data provided by the user prior to the store visit includes data collected from one or more Internet of Things (IoT) devices associated with a user profile, wherein the one or more IoT devices associated with the user profile are utilized in monitoring consumption patterns and product preferences of the user, and wherein the data provided during the store visit includes one or more responses to one or more prompts displayed to the user on the end user device and product information for one or more products for which the user is interacting with during the store visit, wherein the product information is retrieved from a catalog of products maintained in the knowledge corpus for a store associated with the store visit based on an analysis of video feed received from the end user device using one or more image analysis tools, wherein the one or more image analysis tools utilize at least object segmentation techniques and pre-trained classifiers.

5. (canceled)

6. The method of claim 1, wherein the one or more rewards presented to the user in the user interface on the end user device are updated intermittently as additional thresholds are exceeded.

7. (canceled)

8. A computer system for enhancing a customer experience, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
collecting data for a store visit;
determining whether to offer a user one or more rewards based on the data collected and one or more thresholds corresponding to one or more user activities;
determining the one or more rewards to offer the user, wherein the one or more rewards are determined utilizing a machine learning model based on exceeding at least one of the one or more thresholds and an analysis of the data collected for the store visit;
presenting the one or more rewards to the user on an end user device, wherein the one or more rewards are ranked within a user interface based on an intent of the user's store visit, and wherein the user selects at least one of the one or more rewards in the user interface; and
receiving feedback from the user with respect to the one or more rewards, in response to one or more prompts displayed on the end user device, wherein the feedback is stored in a knowledge corpus and utilized in improving future reward offer determinations by the machine learning model.

9. The computer system of claim 8, further comprising:
program instructions, stored on at least one of the one or more computer-readable storage media for execution by at least one of the one or more processors via at least one of the one or more memories, to adjust the one or more thresholds corresponding to the one or more user activities based on a quality or quantity of the feedback received.

10. The computer system of claim 8, further comprising:
program instructions, stored on at least one of the one or more computer-readable storage media for execution by at least one of the one or more processors via at least one of the one or more memories, to provide assistance to the user during the store visit, wherein the assistance includes a personalized map from item to item of a shopping list based upon a Global Positioning Systems (GPS) data received from a smart wearable device associated with the user.

11. The computer system of claim 8, wherein collecting data for the store visit further comprises:
program instructions, stored on at least one of the one or more computer-readable storage media for execution by at least one of the one or more processors via at least one of the one or more memories, to utilize at least data provided by the user prior to the store visit and during the store visit, wherein the data provided by the user prior to the store visit includes data collected from one or more Internet of Things (IoT) devices associated with a user profile, wherein the one or more IoT devices associated with the user profile are utilized in monitoring consumption patterns and product preferences of the user, and wherein the data provided during the store visit includes one or more responses to one or more prompts displayed to the user on the end user device and product information for one or more products for which the user is interacting with during the store visit, wherein the product information is retrieved from a catalog of products maintained in the knowledge corpus for a store associated with the store visit based on an analysis of video feed received from the end user device using one or more image analysis tools, wherein the one or more image analysis tools utilize at least object segmentation techniques and pre-trained classifiers.

12. (canceled)

13. The computer system of claim 8, wherein the one or more rewards presented to the user in the user interface on the end user device are updated intermittently as additional thresholds are exceeded.

14. (canceled)

15. A computer program product for enhancing a customer experience, comprising:
one or more non-transitory computer-readable storage media and program instructions stored on at least one of the one or more tangible storage media, the program instructions executable by a processor to cause the processor to perform a method comprising:
collecting data for a store visit;
determining whether to offer a user one or more rewards based on the data collected and one or more thresholds corresponding to one or more user activities;
determining the one or more rewards to offer the user, wherein the one or more rewards are determined utilizing a machine learning model based on exceeding at least one of the one or more thresholds and an analysis of the data collected for the store visit;
presenting the one or more rewards to the user on an end user device, wherein the one or more rewards are ranked within a user interface based on an intent of the user's store visit, and wherein the user selects at least one of the one or more rewards in the user interface; and
receiving feedback from the user with respect to the one or more rewards, in response to one or more prompts displayed on the end user device, wherein the feedback is stored in a knowledge corpus and utilized in improving future reward offer determinations by the machine learning model.

16. The computer program product of claim 15, further comprising:
program instructions, stored on at least one of the one or more computer-readable storage media, to adjust the one or more thresholds corresponding to the one or more user activities based on a quality or quantity of the feedback received.

17. The computer program product of claim 15, further comprising:
program instructions, stored on at least one of the one or more computer-readable storage media, to provide assistance to the user during the store visit, wherein the assistance includes a personalized map from item to item of a shopping list based upon a Global Positioning Systems (GPS) data received from a smart wearable device associated with the user.

18. The computer program product of claim 15, wherein collecting data for the store visit further comprises:
program instructions, stored on at least one of the one or more computer-readable storage media, to utilize at least data provided by the user prior to the store visit and during the store visit, wherein the data provided by the user prior to the store visit includes data collected from one or more Internet of Things (IoT) devices associated with a user profile, wherein the one or more IoT devices associated with the user profile are utilized in monitoring consumption patterns and product preferences of the user, and wherein the data provided during the store visit includes one or more responses to one or more prompts displayed to the user on the end user device and product information for one or more products for which the user is interacting with during the store visit, wherein the product information is retrieved from a catalog of products maintained in the knowledge corpus for a store associated with the store visit based on an analysis of video feed received from the end user device using one or more image analysis tools, wherein the one or more image analysis tools utilize at least object segmentation techniques and pre-trained classifiers.

19. (canceled)

20. The computer program product of claim 15, wherein the one or more rewards presented to the user in the user interface on the end user device are updated intermittently as additional thresholds are exceeded.

21. The method of claim 1, wherein the intent of the user's store visit is determined based on the one or more thresholds exceeded by the user and the analysis of the data collected for the store visit using one or more linguistic analysis techniques, wherein the one or more linguistic analysis techniques includes at least Natural Language Processing.

22. (canceled)

23. The computer system of claim 8, wherein the intent of the user's store visit is determined based on the one or more thresholds exceeded by the user and the analysis of the data collected for the store visit using one or more linguistic analysis techniques, wherein the one or more linguistic analysis techniques includes at least Natural Language Processing.

24. (canceled)

25. The computer program product of claim 15, wherein the intent of the user's store visit is determined based on the one or more thresholds exceeded by the user and the analysis of the data collected for the store visit using one or more linguistic analysis techniques, wherein the one or more linguistic analysis techniques includes at least Natural Language Processing.

26. The method of claim 1, wherein the machine learning model utilizes two or more machine learning algorithms, wherein the two or more machine learning algorithms are specific to a type of data collected for the store visit, and wherein the feedback received from the user is utilized as additional input for a corresponding machine learning algorithm.

27. The method of claim 1, wherein the data collected for the store visit includes at least consumption patterns derived from one or more smart appliances, and wherein at least one of the one or more thresholds are derived from a professional recommendation made through an integrated medicine-as-a-service practice.
